(19) United States
(12) Patent Application Publication
(10) Pub. No.: US 2013/0054259 A1
(43) Pub. Date: Feb. 28, 2013

(54) Rule-based Prediction of Medical Claims' Payments

(71) Applicants: Janusz Wojtusiak, Fairfax, VA (US); John M. Shiver, Arlington, VA (US)

(72) Inventors: Janusz Wojtusiak, Fairfax, VA (US); John M. Shiver, Arlington, VA (US)

(21) Appl. No.: 13/401,942

(22) Filed: Feb. 22, 2012

Related U.S. Application Data
(60) Provisional application No. 61/445,203, filed on Feb. 22, 2011.

(51) Int. Cl. G06Q 50/22; G06Q 10/00

(52) U.S. Cl. 705/2

(57) ABSTRACT

Some embodiments of the present invention evaluate claim submissions. Prediction(s) are generated that employ machine learning engine(s) and/or expert models executing on processor(s). The prediction(s) may forecast if claim data when submitted to a payer will result in at least one of the following: an approved submission; a denied submission; and an apparent payment variation. The machine learning engine(s) may be updated using use the prediction. Labeled data may be generated by classifying patient claim data residing in a database of claim records and histories with at least one of the following: an anomaly detection label; a contract based label; and a combination of the above. Claims classification model(s) may be trained using the labeled data. Predictive paid amount model(s) may be created that employ at least the labeled data and/or an amount paid on a claim.

### CROSS-REFERENCE TO RELATED APPLICATIONS

This application claims the benefit of U.S. Provisional Application No. 61/445,203, filed Feb. 22, 2011, entitled “Healthcare Financial Management Artificial Intelligence,” which is hereby incorporated by reference in its entirety.

### BACKGROUND

Significant amounts of money may be lost due to waste, fraud, and abuse with regard to claim processing in many fields such as healthcare, insurance (e.g. automobile, home, long term care), or banking. For example, according to a study released by the American Medical Association, the healthcare system in the United States consumes as much as $210 billion each year on claims processing while as many as one in five claims are processed inaccurately. This may include documentation and revenue cycle management for hospitals, medical group practices, and individual physicians. Across the country, healthcare providers may be experiencing ongoing pressure from declining revenues. Payers may need to increasingly contain costs. The implementation of healthcare reform through the Patient Protection and Affordable Care Act (PPACA) may exacerbate this issue.

Each payer (government and private) may have proprietary documentation standards, service groupings, and client eligibility standards specific to their various product offerings and billing compliance standards. As individual claimants have multiple payer coverage and as various providers accept customers with many different payer contracts (each with varying requirements), the management of the billing process and assuring compliance with established standards may be complex.

### BRIEF DESCRIPTION OF THE SEVERAL VIEWS OF THE DRAWINGS

FIG. 1 illustrates sample payments received for a subset of Medicaid patients in 2008 for a specific service.

FIG. 2 is a block diagram showing an architecture of an aspect of an example embodiment of the present invention.

FIG. 3 is an example block diagram showing three optional levels of bill classification models according to an aspect of an embodiment of the present invention.

FIG. 4 is a block diagrams showing an example training architecture according to an aspect of an embodiment of the present invention.

FIG. 5 is a block diagrams showing an example training architecture according to an aspect of an embodiment of the present invention.

### DETAILED DESCRIPTION OF EMBODIMENTS

Some embodiments of the present invention evaluate payment or payment request submissions (e.g. healthcare services, insurance reimbursement, banking). For example, some embodiments of the present invention may employ rule learning to advance healthcare provider revenue cycle management. According to some embodiments, advanced machine learning may be configured to derive, from historical claims data, support/screening models specific to each payer and insurance product or plan. Example models may be subsequently applied to classify new claims. As such, the example models maybe employed to screen claims for proper documentation prior to submission for payment. In doing so, a provider may prospectively reduce the number and frequency of payment denials for improper claim submissions. Additionally, some embodiments may be configured to derive more specific example models for analyzing reimbursements to match payment for service(s) to invoice(s). By matching invoices to individual Explanations of Benefits (EOB), the provider may detect payment discrepancies by payers. By utilizing patterns detected from past data and management's experience, information that is indiscernible to an individual using manual techniques, these patterns may be documented and analyzed. This information may give the provider documentable patterns of errors and allow for early corrective actions.

Some embodiments of the present invention may be configured to predict prior to submission if a specific claim will be processed correctly and receive full payment, or processed incorrectly and declined or not paid in full; and detect regularities in incorrectly processed claims both on the provider and payer sides. Example embodiments may include at least: detection of normal payment levels (anomaly detection), creation of rule-based classification, classification of new claims, a combination thereof, or the like.

Some embodiments of the present invention may focus on the provider data, understandability and usability of the created models, the ability to deal with both very large and much smaller datasets, and in not using the actual contract information. This is in contrast to systems that focus mainly on the analysis of massive amounts of data, mainly derived from insurance companies, in order to detect fraudulent claims.

Embodiments may be applied to both large hospitals, as well as smaller providers, including private practices with only few physicians, and clinics. Embodiments of the present invention may be applied to government payers (e.g., Medicare, Medicaid, national insurance in different countries) payments, as well as private payers and itemized claims, or any combination of thereof.

Data-Driven Approach

Billed amounts may be determined based on contracts between providers and payers (e.g. insurance companies). The contracts may define the amounts to be paid for a specific service, or a group of services provided.

Example embodiments presented in this section may be employed to label data for which payments are already received. These may include, for example, historical data used for machine learning-based model construction, and newly received payments that may be used to update existing models. Creating and updating machine learning models, described later in this disclosure, may require labeled data with claim(s) classified as, for example, normal or abnormal. Claims that follow payment pattern may be assumed, in some embodiments, to be normal, and those for which payments do not fit the pattern may, in some embodiments, be assumed to be abnormal.

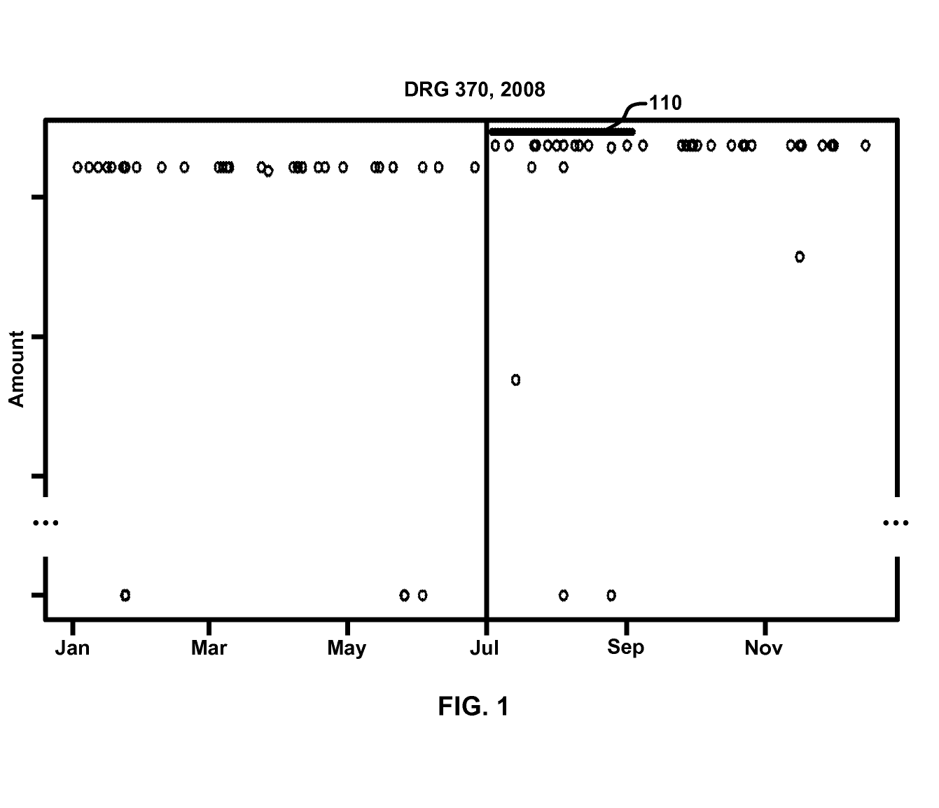

According to some embodiments, a data-driven approach may explicitly ignore contract information. Instead, some embodiments may discover amounts that are paid by observing payment trends for a specific payer or a group of payers. For a specific payment received, the payment value may be compared to previous discovered payments received. If the amounts are the same, the payment may be classified as correct. Otherwise, payments may be analyzed within a look-forward window of k days, including the day of that claim. If the majority of payments in the window equal the new amount, the payment may be marked as a correct payment, and new level of payment may be set with the start date corresponding to the admission date corresponding to the first claim in the window. Otherwise, when the majority of payments are not equal to the analyzed payment, the payment may be annotated as abnormal (with additional classification to zero, below normal, and above normal). FIG. 1 illustrates sample payments received for a subset of Medicaid patients in 2008 for a specific service. In the beginning of July, the amount increased which is detected by the methodology and marked with a horizontal line 110. This horizontal line 110 may reflect the use of a 30-day look-forward window. Six payments below the July 2008 new normal level of payment may be classified as abnormal. A default look-forward window size may, for example, be 30 days, however, the window size may be adapted to specific payers and services provided.

System Architecture

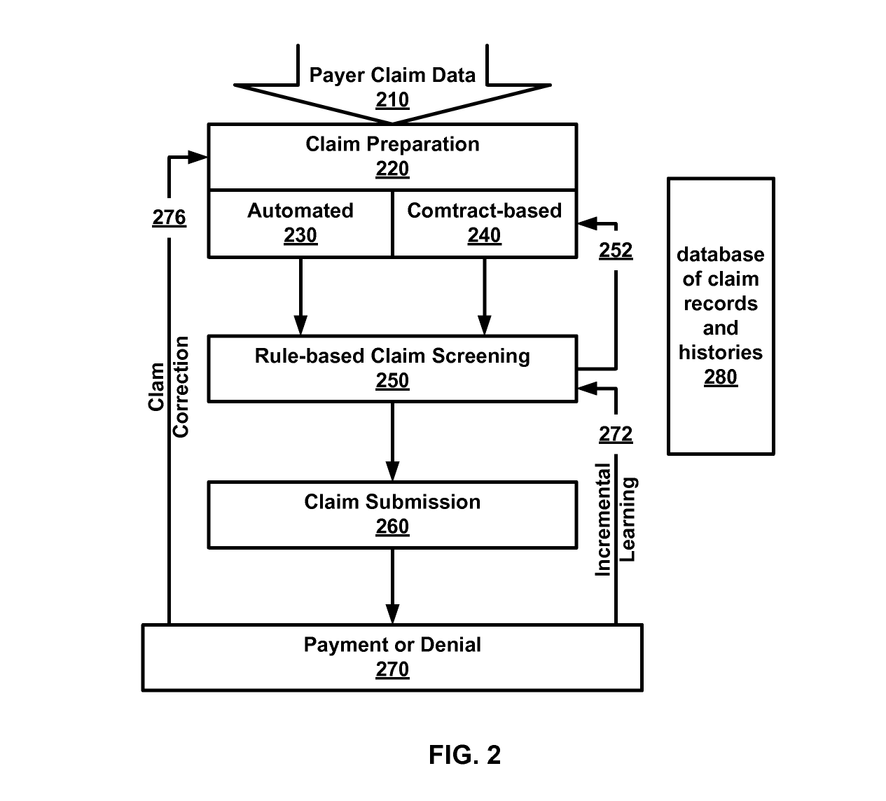

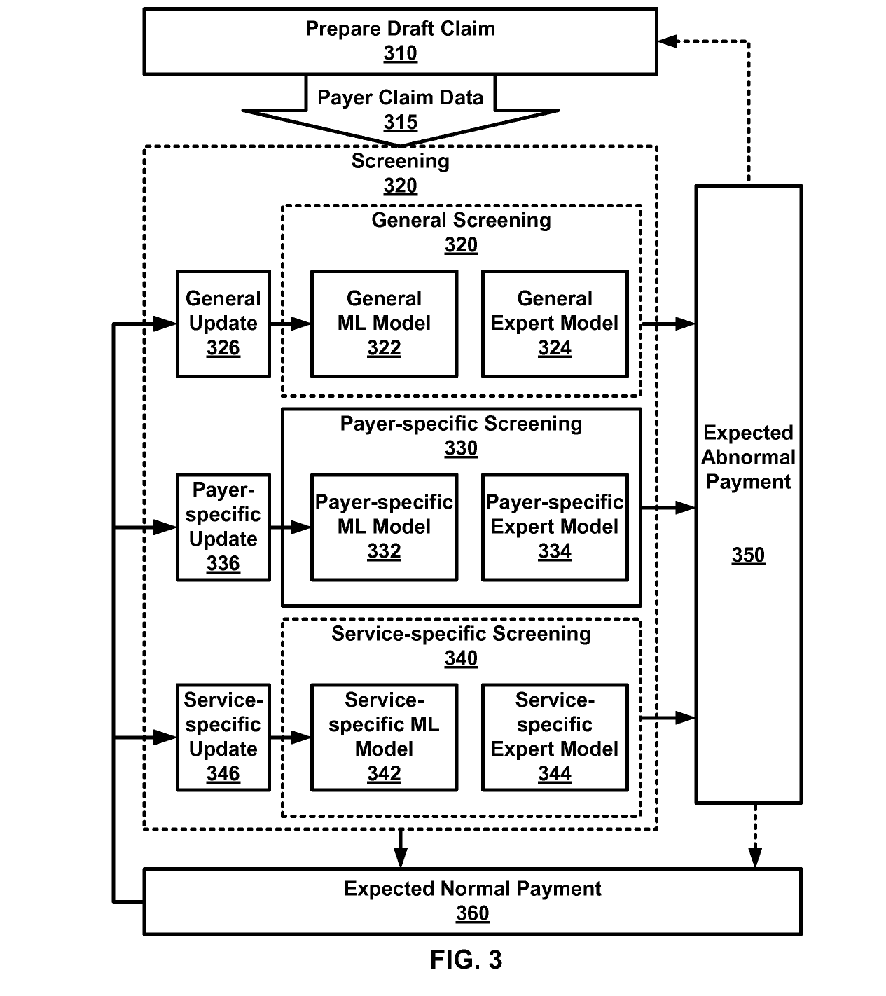

FIG. 2 is a block diagram showing an architecture of an aspect of an example embodiment of the present invention. This illustrated example may include components such as: claim preparation 220, automated analysis 230, contract-based analysis 240, rule-based claim screening 250, claim submission 260, payment (or denial) 260, and database(s) of claim records and histories 280. Payer Claim data 210 may be coded into nomenclatures such as ICD-9, ICD-10, DRG, HCPCS, or the like at 220. According to various embodiments of the present invention, claim preparation 220 may include automated preparation 230 and/or contract-based preparation 240. Traditional contract-based claim preparation 240 may involve software and the knowledge of personnel that prepare bills. At the same time, a data-driven preparation 230 (an example of which was described in the previous section) may be employed to estimate expected payments. Claims may be passed through rule-based screening module 250 to detect potential discrepancies (see. e.g., FIG. 3). Suspicious claims may be marked and passed on for further review before submission as indicated by arrow 252 pointing to contract-based claim preparation 240. Claims that pass through the rule-based screening 250 may be submitted to payers at 260. Payments or denials may be received at 270. Learning information 272 may be incrementally fed back to the rule-based claim classification 250 to account for new situation (s) and changing environment(s). Similarly, claim corrections 276 may be fed back to the claim preparation 220 to update the claim.

Characteristics of some example embodiments include:

Combination of data-driven preparation 230 and contract-based claim preparation 240: There may be several reasons for underpayments or claim denials already known by claims management personnel. There may not be a need to analyze large amounts of data, to find what is already known, but rather focus on rare and unexpected discoveries in data. Thus, only access to smaller amounts of data may be needed, and detection of patterns may be performed faster than when searching all patterns.

Rule-based system for classifying claims: Embodiments may combine user-defined rules that cover already known cases with machine learning-discovered rules. The rationale for using rules is that they may be highly transparent, and may achieve accuracy comparable to other forms of classifiers (i.e., SVM, random forests, logistic regression). Also, rules may be employed in decision support systems without much additional preparation or conversion.

The ability to automatically adapt to changing environment: Healthcare environment(s) as well as other environment(s) considered in this disclosure may constantly change, providers' and payers' behavior(s) may change, new contracts may be signed, and new personnel may be responsible for processing claims. The dynamic nature of the problem may call benefit from embodiments that may automatically detect changes and adapt to them. Some embodiments may be configured to employ incremental machine learning algorithms for doing so.

Some embodiments may utilize a rule-based screening element 250. Rules in element 250 may be automatically derived from data by employing machine learning, briefly described in the following section. The approach may be based on an ensemble of models (e.g. classifiers 322, 324, 332, 334, 342, and 344) as depicted in example FIG. 3. According to several embodiments, models may be automatically derived from data, created manually by experts, created by combination of the two methods, or the like. A rationality behind using combination of automated and expert-based construction of models is to avoid discovering obvious relations in the data (that may be easily described by experts in the form of rules), and on the other hand be able to detect reasons for denials specific for different payers, which may remain unknown even for well-trained individuals or impossible to detect using standard computing techniques.

The following actions may be employed to create models:

Retrieve data: Data may be retrieved from a billing system or an electronic medical record system. For a study employing an example embodiment, de-identified billing data for years 2008 and 2009 including both paid and unpaid claims were used. For simplicity, the study focused on obstetrical data, and used only Medicaid payments.

Preprocess data: According to some embodiments, data may be preprocessed at 310. Data may be checked for completeness and consistency. This may include exploratory data analysis needed to gain better understanding of attributes, values, distributions of provided examples, etc. After the check, missing values may be resolved by inserting basic forms of missing values such as unknown values and not applicable values. New attributes may be derived from the data to describe high-level billing information and some additional properties such as numbers of empty fields, list empty fields, time from the contract change date, combinations of values in specific fields, or the like. Additionally, time-based attributes, which may account for previous visits and claims that affect payments, may be derived. In some example embodiments, data processing may be performed using SQL scripts, R scripts, a combination thereof, or the like.

Create models: According to some embodiments, models may be induced from data, acquired from experts, created by combining the two, or the like.

Learn models from data: According to some embodiments, rule-based machine learning software may be employed to create models from data. Rule-based models may provide a “white box” approach in which learned models may be inspected by human experts and appropriately modified, if needed. The models can also provide useful knowledge to experts. An AQ21 machine learning engine developed at George Mason University of Fairfax, Va. was used in some embodiments to derive rules. A machine learning engine may include an algorithm or computer program running on one or more processors, a device, or a combination of these, that is capable of making predictions based on data, past experience, instruction, or a combination thereof. One skilled in the art will recognize that other machine learning machines beside the AQ21 may be used. For example, support vector machines, decision trees, Bayesian networks, or the like.

Manually acquire models: According to some embodiments, simple models may be acquired from human experts to represent basic reasons for denials (i.e. missing key information). Thus, there may not be a need to analyze massive amounts of data to discover obvious patterns that are well known. One of the aspects of the present embodiments is to create models for detecting unexpected patterns of payment that can contribute to experts' knowledge and combined with existing models accurately predict payments.

Apply models: According to some embodiments, models may be applied in order to categorize previously unseen claims as normal, abnormal, or the like. Additionally, abnormal claims may be further categorized as: above normal, below normal, zero, or the like. Among claims classified as abnormal, it may be possible to perform regression learning in order to determine most likely level of payment. According to some embodiments, classification learning may be performed before regression learning.

Test: According to some embodiments, models may be tested before applied in a real world system. For example, about 20-30% of data with known outcomes may be set aside and used for testing. Due to an possibly relatively small number of abnormal payments and the need to preserve sequence of data, one year of data may be used that followed one year of data used for training models.

Rule Learning

Rules may be a type of knowledge representation used in healthcare. Machine-learning may be able to derive rules from data. Rule-based knowledge representation may satisfy several criterions in healthcare applications:

Accuracy: Rule-based models may achieve predictive accuracy comparable to other types of models considered in machine learning. Although usually not scoring top in terms of accuracy, rules may provide predictions that are good enough for some applications. Accuracy is usually the major criterion considered for quality of learned models.

Transparency: Rule based models may be the most transparent and easiest to understand by people not trained in machine learning or statistics. This may be important in field such as healthcare where the decision makers (both medical and administrative) need to clearly understand rationale for the decisions being made.

Efficiency: Application of rule-based models may be fast and thousands of rules may be processed every second. For example, rule-based models may be appropriate in large-scale decision support systems operated by multiple users in complex environments.

Transferability: Decision support systems may be rule based thus rules resulting from machine learning applications may be used with only minimum change.

Attributional Rules

Despite their popularity, standard IF . . . THEN rules, which use only conjunctions of simple statements, have limited expression power. More expressive form of rules may be used in embodiments. Specifically, attributional rules may be used to represent at least some of the knowledge used in embodiments, an example form of which may be given by:

CONSEQUENT<=PREMISE|_EXCEPTION:ANNOTATION

Both CONSEQUENT and PREMISE are conjunctions of attributional conditions in the form:

[L REL R:A]

The symbols <=, and |_ denote implication and exception operators, respectively. EXCEPTION may include an exception clause in the form of a conjunction of attributional conditions or an explicit list of examples constituting exceptions to the rule. ANNOTATION may include an additional statistical description, including, for example, the rule's coverage.

According to some embodiments, an attributional condition may correspond to a simple natural language statement. In the example general form shown above: L is an attribute, a counting attribute (derived from other attributes), or a simple arithmetical expression over numerical attributes; R is an attribute value, internal disjunction or conjunction of values, a range, or an attribute; REL is a relation applicable to L and R; and A is an optional annotation that provides statistical information characterizing the condition. The annotation may include numbers of cases satisfied by the condition and its consistency. According to some embodiments, when L is a binary attribute REL and R may be omitted. Several other forms of attributional rules may be available which resemble statements in natural language, and thus may be interpretable by people not trained in machine learning.

Rule learning may result in more than one rule outputted by a system. In some of the example embodiments, independent rules may be used. In independent rules, the fact that one rule “fires” may not tell anything about other rules, i.e., the rules do not need to be evaluated in a sequence. In attributional calculus, a set of rules with the same CONSEQUENT may be called a ruleset. Rules in a ruleset may represent different reasons for classifying to the same category. For example, there may be three different rules that all classify claims as potentially abnormal. A ruleset family, sometimes called a classifier, may include a set of rulesets that span over possible categories in data.

Learning Algorithm

In some examples, rule-based machine learning (such as the AQ21) may be used to learn attributional rules for predicting claims' payments. AQ21 machine learning or the like may provide users with high flexibility and applicability to a wide range of problems. AQ21 learning machines may create rules by sequentially covering examples from a given class and avoiding examples from all other classes. This may be accomplished by executing a set of logical operators accompanied by statistical rule quality measures, and rule simplicity measures. AQ21 learning may allow for batch rule generation from historical data, as well as incremental modification of existing rules when new data are available.

Learning machines such as AQ21 may be highly configurable and robust, with features specifically useful in learning form healthcare data. Some features may include the ability to: learn from multi-type data (nominal, ordinal, structured (a.k.a. hierarchical), set-valued, interval, ratio, compound attributes, or the like); automatically improve representation space through constructive induction; deal with noise in the data; handle unknown, not-applicable, and irrelevant meta-values; learn unordered, structured, or linearly-ordered rule sets; learn from aggregated data and published results; use background knowledge; deal with very small and very large datasets; generate natural language output; or the like.

From Rules to Decision Support

Because rules created by learning machines may be independent (i.e. unordered), the rules may be incorporated into decision support systems. For example, attributional rules described above may be directly written in a procedural language that represents medical algorithms in clinical information systems as knowledge modules (Medical Logic Modules (MLMs)). An example of such as procedural language is ARDEN.

According to some embodiments, actual rules may be written in the “logic” slot of MLMs and the “data” slot employed to derive attributes' values and translate them into the required format. Because one MLM corresponds to a complete decision, it may include multiple rules forming a complete ruleset family. Attributional rules may also be manually inspected by experts and modified as rules and compliance requirements change.

Data

Data used with an example embodiment of the present invention was derived from a hospital billing system and initially pre-processed using R scripts. An SQL database was used to further pre-processing the data for the AQ21 system to create rule-based models.

Data tables may represent patients' demographics, clinical (hospital) information, insurance, and charges. The total number of attributes in the example data was 55. The original data consisted of 26,689 records in the demographics and hospital tables, and 30,449 records in the insurance table.

The data preprocessing identified Medicaid patients in the data. Some patients were double-eligible and their financial status in the system may not have reflected this fact. In addition to eligibility criteria, claims for identified Medicaid patients were retrieved.

The example embodiment of the present invention calculated “normal” values of payment and dates on which the normal values change. For Medicaid payments values of payment correspond to Diagnosis Related Groups (DRGs)—the basis for payment.

For each patient with a Medicaid claim, the total received amount was calculated. The amount was compared to the normal payment and claims classified as: zero, below normal, normal, and above normal.

For the initial analysis using the example embodiment, 23 attributes were selected: age, marital status, city, county, state, zip code, employer status code, payor name, admission date, length of hospital stay, admission source, admission type, DRG, ICD-9-CM diagnostic code, ICD-9-CM procedure code, contract identification, covered charges, non-covered charges, covered days, deductible, coinsurance, paid amount, and contractual adjustment. After further elimination, a subset of 14 attributes were selected for the rule learning algorithm. This subset of attributes came as a result of performing data-quality checks such as correlation, outlier detection and examining the predictive power of the attributes. Also, attributes whose values were not known prior to claims' submission were eliminated.

The example test subset contained a total of 972 Medicaid records in the 2008 training set and 1005 in the 2009 test set (Table I). The data was exported from the SQL database into a single flat text file configured to be uploaded to the AQ21 and other machine learning machines.

Selected Results

An example embodiment of the present invention has been applied off-line to a set of claims and payments. For simplicity, the initial work focused on obstetrics data and only on Medicaid payments. For Medicaid claims, payments strictly depended on patients' Diagnosis Related Group (DRG). DRG may be used to classify patients based on diagnoses and services provided and may be the basis for Medicaid reimbursement. For example, all women that deliver through cesarean section without complications may have DRG 370.

Example payments for patients with DRG 370 in 2008 were presented earlier in FIG. 1. Despite the simplicity of the data, there are cases present where payments deviate from normal. The dataset was selected as a test-bed for the example embodiment.

The data were loaded to the AQ21 rule learning machine. The payer-specific model based on all used Medicaid OB patients was created. Specific models for OB-related DRGs were created. An example rule is shown below. It is one of several rules derived from data. Information about specific payers, and patient information has been encrypted.
[payment=below_normal,zero]
<==[marital_status=S,U,X] &
   [zip=ZIP1, ZIP2, ZIP3, ZIP4, ZIP5] &
   [length_stay>=1] &
   [admin_type_id=3] &
   [contr_id=XX1, XX2, XX3, XX4, XX5, XX6]
      : p=9, n=2, q=0.733, cx=55

In this example, the rule states that the payment is abnormal (zero or below normal) if patient's marital status is S or U or X, patient's zip code is one of the listed codes, length of stay is at least one day, and so on. At the end of the rule, the listed numbers show numbers of abnormal and normal payments satisfying the rule, the rule's quality, and the rule's complexity. Commas separating values within conditions represent internal disjunction, for example in the rule CONSEQUENT, payment is below normal or zero.

Models created using 2008 data were tested on 2009 data. The rules were able to detect about 50% of abnormal payments. The models incorrectly classified only between 5% and 30% of normal payments. A provider-specific model for Medicaid payment was built and tested. Service-specific models for patients with different DRGs were constructed and tested. Summary of the results is presented in Table II.

The results indicate that the example embodiment was able to detect abnormal payments in hospital claims data. The 50% detection rate, seems relatively low, but is actually good for this specific dataset. Note that the false positive rate is much lower. This result has significant potential impact on financial management, because detection of even half of incorrectly processed claims may lead to large savings.

TABLE II
Numbers and Rates of Abnormal Payments Automatically
Identified in 2009 Data.

| | Detected | |
|---|---|---|
| Model | Abnormalities | False positives |
| Medicaid | 21/35 (60%) | 149/939 (16%) |
| DRG 371 | 4/8 (50%) | 77/330 (23%) |
| DRG 372 | 6/11 (55%) | 4/72 (5%) |
| DRG 373 | 7/16 (44%) | 142/472 (30%) |

Some of the various embodiments of the present invention evaluate claim submissions 210. Some of the various embodiments of the present invention may include a non-transient computer readable medium that includes a series of computer readable instructions configured to cause one or more processors to execute a method for evaluating claim submissions 210 from a first party to a payer. Some of the various embodiments of the present invention may employ machine learning engine(s) executing on one or more processors. First parties may include service providers, patients, loan applicants, and/or insurance clients, or the like. A payer may include an entity to whom claims are sent in order to receive payment. Payers may include insurance companies, private people, government entities, and foundations. Claims data may include information used by machine learning engine(s), including medical claims, insurance claims, grants, loans applications, bills submitted to payers by healthcare providers, coded data, additional evidence, medical history of patients, socioeconomic status of patients, information describing healthcare providers and payers, combinations thereof, and/or the like.

According to some of the various embodiments, claim data may be pre-filtered and/or internally filtered at a claim preparation phase 220. For example, in some embodiments, claim data 210 may be compared against a database of claim records and histories 280 for completeness and consistency. The database of claim records and histories 280 may include new claim data, previous claim data, a combination thereof, or the like. A database may be an organized collection of data for one or more purposes, usually in digital form. The term database may refer to data, supporting data structures, and/or the like. In at least some of the present embodiments, a database may include a multitude of claim data. According to some embodiments, the database of claim records and histories 280 may be accessed using a database system. The database system may include a general-purpose database management system (DBMS) such as Oracle, IBM ID2, Microsoft SQL Server, My SQL, or the like.

According to some of the various embodiments, claims data may be de-identified. De-identified data may include data with removed information identifying patient or patients. Information identifying patient may include, but is not limited to: patient name, address, social security number, date of birth, combination(s) thereof, and/or the like. De-identification may useful when privacy is to be protected.

According to some of the various embodiments, patient billing data may be formatted into a machine learning data format. Machine learning data format(s) include a data form that may be directly loaded to or read by machine learning engine(s). Machine learning engine(s) may include a machine configured to make predictions based on data, past experience, instruction, a combination thereof, or the like. Examples of a machine learning engine(s) include, but are not limited to: an algorithm in combination with computing hardware, a computer program in combination with computing hardware, a device, a combination thereof, and/or the like.

According to some examples, the database of claim records and histories 280 may be employed to resolve missing value(s) in the patient billing/claim data. Claim information may include information on a claim submitted to payers such as healthcare providers. In the case of the payee being a healthcare provider(s), the information may include: coded data, additional evidence, medical history of patients, socioeconomic status of patients, information describing healthcare providers and payers, combinations of the above, and/or the like. Missing value(s) may include a part or parts of data which are: present because it is not known; known but not recorded; not applicable; irrelevant; a combination thereof; and/or the like. Examples of missing value(s) may include, but are not limited to: visit date(s); claim information such as name, address, diagnosis, and/or prescription, or the like. Visit dates may include date, time, or their combination of patient's visit to the provider. So, for example, if it is determined that a visit date is missing from a medical claim, the database of claim records and histories 280 may be employed to determine the probable data value for the visit date for the medical claim. Additionally, the database of claim records and histories 280 may be employed to locate and fix typographical errors in such fields as the name of a patient, an insurance plan identifier, an address, and/or the like.

According to some embodiments, machine learning engine(s) executing on processor(s) generate prediction(s) that may forecast if claim data 210 when submitted to a payer will result in at least one of the following: an approved submission; a denied submission; and an apparent payment variation. A prediction may include a process in which given a set of observations or characteristics of an objects other previously unknown characteristics of that objects are revealed. In some embodiments, the unknown characteristics may include factors that a particular payer considers in making a payment decision. An approved submission may include a submission of a claim that results in a claim being paid in the full requested amount. A denied submission may include a submission of a claim for which payment is not received. An apparent payment variation may include a submission in which the paid amount differs from the requested amount. In some of the various embodiments, an amount for apparent payment variation(s) may be predicted.

According to some of the various embodiments, machine learning engine(s) may determine pattern(s). A pattern may include a repeating value or a set of values in data. Some value(s) may repeat in a predictable manner. However, some patterns may be less predictable and may include numerous variants. Detecting pattern(s) and variants from a large data set may be beyond the capacity of a human. Models may be employed to detect these underlying pattern(s).

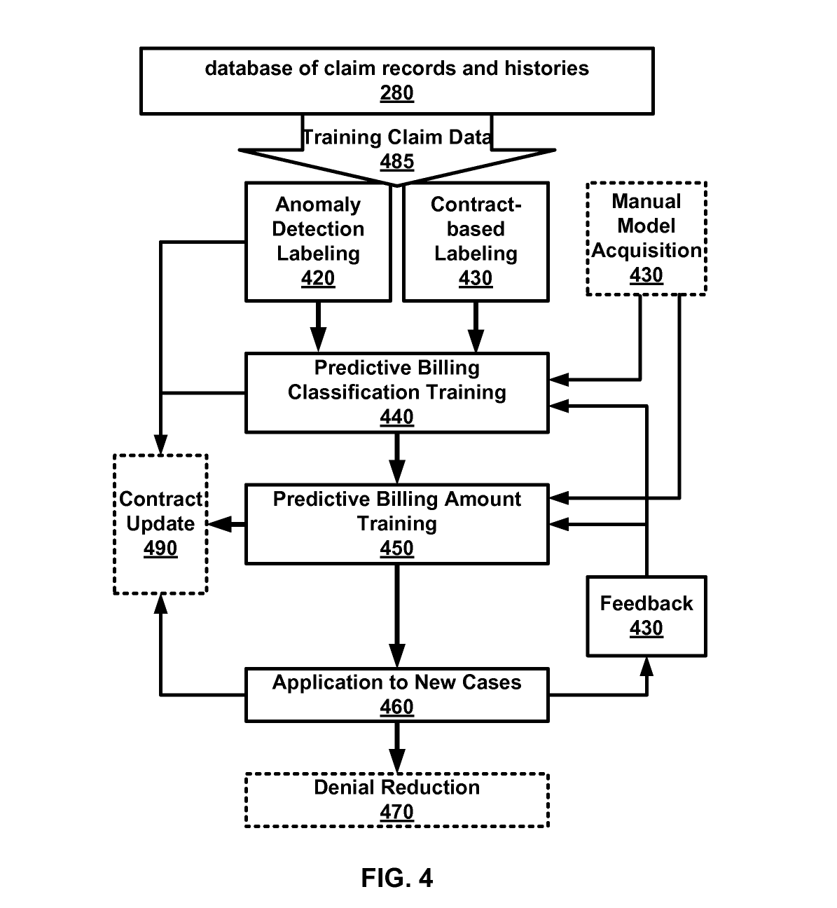

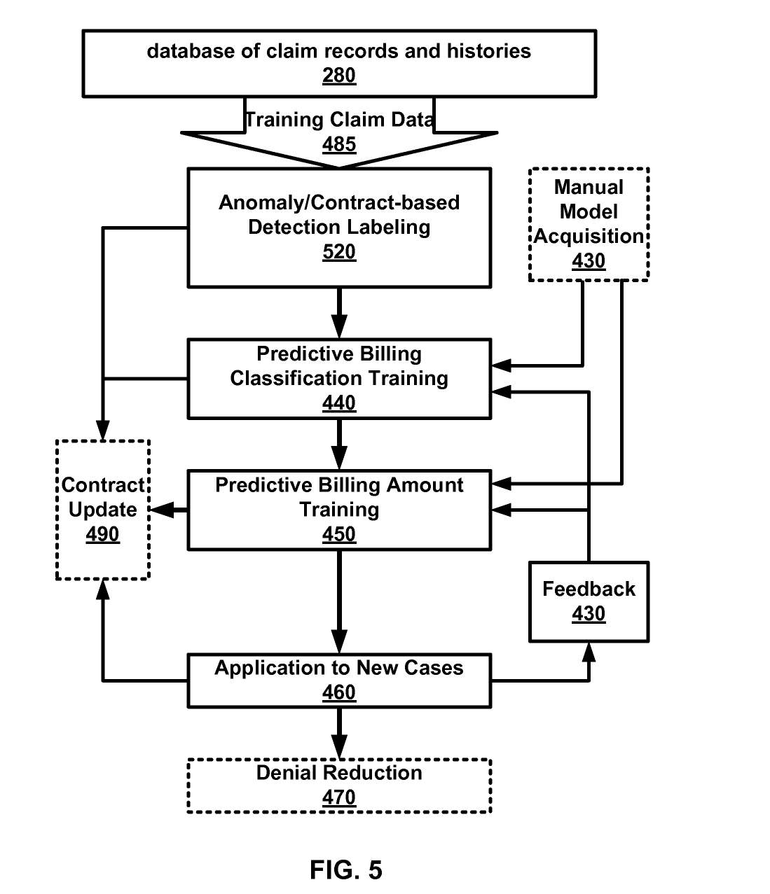

FIG. 4 and FIG. 5 are block diagrams of showing example training architecture(s) as per aspects of embodiments of the present invention.

According to some embodiments, machine learning engine(s) may be updated using use the prediction. Labeled data may be generated by classifying training claim data 485 from the database of claim records and histories 280 with at least one of the following: an anomaly detection label; a contract based label; and a combination of the above. Examples of labels may include, but are not limited to labels identifying approved submissions, denied submissions, apparent payment variations, a combination of the above, or the like. Labeled data may include expert specified label(s). Expert specified label(s) may include anomaly detection label(s) or contract-based label(s) assigned by an expert or experts.

According to some embodiments, at 420, anomaly detection label(s) containing information relating to approved submission(s), denied submission(s), or apparent payment variation(s) may be assigned to training claim data 485. The information may be assigned by analyzing difference between submitted payments. This analysis may, according to various embodiments may be performed employing an algorithm in combination with a machine, a person in combination with a machine, a machine, a combination of the above, and/or the like.

According to some embodiments, at 430, contract based label(s) containing information relating to approved submission(s), denied submission(s), or apparent payment variation(s) may be assigned to training claim data 485. The information may be assigned by analyzing contracts between payers and providers, tables of typical payments, specific fee schedules, a combination of the above, and/or the like. This analysis may, according to various embodiments may be performed employing an algorithm in combination with a machine, a person in combination with a machine, a machine, a combination of the above, and/or the like.

According to some of the various embodiments, claims classification model(s) may be trained using the labeled data at 440. The claims classification model(s) may include a manual model(s). A manual model may include an instruction obtained from experts, literature, a combination of the above, and/or the like. A claims classification model may include a method for assigning information about approved submission, denied submission, apparent payment variation, combination(s) of the above, and/or the like to data in the data in database of claim records and histories 280, previously unseen data, a combination of the above, and/or the like. A claims classification model may be created by machine learning engine(s), acquired from expert(s), derived from literature, a combination of the above, or the like.

According to some of the various embodiments, a predictive paid amount model(s) may be created at 450, that employ at least the labeled data, an amount paid on a claim, a combination thereof, and/or the like. An amount paid on a claim may include the amount of money received from payer as a result of a claim submission.

The predictive paid amount model(s) may include a manual model. A predictive paid amount model may employ a methodology for assigning potential paid amounts to data in the data in database of claim records and histories 280, previously unseen data, a combination thereof, and/or the like. A predictive paid amount model may be created by machine learning engine(s), acquired from expert(s), derived from literature, a combination thereof, and/or the like.

The predictive paid amount model may be created after filtering claims classified as at least one of the following: approved submission claims; denied submission claims; apparent payment variation claims, and/or the like.

According to some of the various embodiments, contract(s) and/or the like may be updated at 490 using at least one of the following: claims classification model(s); predictive paid amount model(s); anomaly detection label(s); a combination thereof, and/or the like. According to some of the various embodiments, claims(s) and/or the like may be updated at using at least one of the following: claims classification model(s); predictive paid amount model(s); anomaly detection label(s); a combination thereof, and/or the like. In some cases, according to some of the various embodiments, a determination to not submit claim(s) and/or the like may be made at 470 employing at least one of the following: claims classification model(s); predictive paid amount model(s); anomaly detection label(s); a combination thereof, and/or the like.

Some of the various embodiments of the present invention may include a non-transient computer readable medium that includes a series of computer readable modules configured to cause one or more processors to execute a method for screening claim submissions 315 from a first party to a payer. FIG. 3 is an example block diagram showing three optional levels of bill classification models that may, among other techniques, be implemented using modules according to an aspect of an embodiment of the present invention. The three levels of bill classification models include general screening module 320, payer-specific screening module 330 and service-specific screening modules 340. As illustrated in this example, screening modules 320 may include: screening module(s) (330, and/or 320, and/or 340) and update module(s) (332, and/or 322, and/or 342).

According to some of the various embodiments, payer-specific screening module 330 may be configured to cause the one or more processors to generate a prediction employing payer-specific machine learning engine(s) 332 and/or payer-specific expert model(s) 334. The prediction may forecast if first patient claim data 315 when submitted to a payer will result in at least one of the following: an approved submission; a denied submission; an apparent payment variation, a combination thereof, and/or the like. If a abnormal payment is forecast, the payer claim data 315 may be forwarded to an expected abnormal payment module 350 that may determine to submit the claim 315 to a payment module 360 and/or forward the claim 315 back for redrafting at a prepare draft claim module 310.

According to some of the various embodiments, payer-specific update module 336 may be configured to update payer-specific machine learning engine(s) 332 using at least prediction(s). The payer-specific machine learning engine(s) 332 may be trained by: (1) generating payer-specific labeled data, (2) employing the payer-specific labeled data to train a payer-specific claims classification model, and/or (3) creating a payer-specific predictive paid amount model. The payer-specific labeled data may be generated by classifying second patient claim data residing in a database of claim records and histories with at least one of the following: payer-specific anomaly detection label(s), payer-specific contract based label(s), a combination thereof, and/or the like. The payer-specific predictive paid amount model(s) may be created by employing at least one of the following: payer-specific labeled data, payer-specific amount(s) paid on a claim, a combination thereof, and/or the like. Additionally, payer-specific screening module 330 may also include a payer-specific expert model 334.

According to some of the various embodiments, general screening module 320 may be configured to cause the one or more processors to generate a prediction employing general machine learning engine(s) 322 and/or payer-specific expert model(s) 324. The prediction may forecast if first patient claim data 315 when submitted to a payer will result in at least one of the following: an approved submission; a denied submission; an apparent payment variation, a combination thereof, and/or the like. If an abnormal payment is forecast, the payer claim data 315 may be forwarded to an expected abnormal payment module 350 that may determine to submit the claim 315 to a payment module 360 and/or forward the claim 315 back for redrafting at a prepare draft claim module 310.

According to some of the various embodiments, general update module 326 may be configured to update general machine learning engine(s) 322 using at least prediction(s). The general machine learning engine(s) 322 may be trained by: (1) generating general labeled data, (2) employing the general labeled data to train a general claims classification model, and/or (3) creating a general predictive paid amount model. The general labeled data may be generated by classifying second patient claim data residing in a database of claim records and histories with at least one of the following: general anomaly detection label(s), general contract based label(s), a combination thereof, and/or the like. The general predictive paid amount model(s) may be created by employing at least one of the following: general labeled data, general amount(s) paid on a claim, a combination thereof, and/or the like.

According to some of the various embodiments, service-specific screening module 340 may be configured to cause the one or more processors to generate a prediction employing service-specific machine learning engine(s) 342 and/or service-specific expert model(s) 344. The prediction may forecast if first patient claim data 315 when submitted to a payer will result in at least one of the following: an approved submission; a denied submission; an apparent payment variation, a combination thereof, and/or the like. If a abnormal payment is forecast, the payer claim data 315 may be forwarded to an expected abnormal payment module 350 that may determine to submit the claim 315 to a payment module 360 and/or forward the claim 315 back for redrafting at a prepare draft claim module 310.

According to some of the various embodiments, service-specific update module 346 may be configured to update service-specific machine learning engine(s) 342 using at least prediction(s). The service-specific machine learning engine(s) 342 may be trained by: (1) generating service-specific labeled data, (2) employing the service-specific labeled data to train a service-specific claims classification model, and/or (3) creating a service-specific predictive paid amount model. The service-specific labeled data may be generated by classifying second patient claim data residing in a database of claim records and histories with at least one of the following: service-specific anomaly detection label(s), service-specific contract based label(s), a combination thereof, and/or the like. The service-specific predictive paid amount model(s) may be created by employing at least one of the following: service-specific labeled data, service-specific amount(s) paid on a claim, a combination thereof, and/or the like.

### CONCLUSION

Machine learning approach to claims management may provide possibilities that go beyond traditional information systems solely based on coding of contracts between payers and providers. Embodiments of the present invention may detect abnormalities in patterns and predict potential abnormalities in future claims before their submission.

Experimental results performed employing an example embodiment of the present invention using Medicaid healthcare payments, showed that the example embodiment was able to detect irregularities in payments. The presented results may be scalable to much larger datasets (AQ21 has been successfully applied to problems with millions of examples and problems with thousands of variables). Embodiments of the present invention may detect irregularities and learn models from the smallest possible datasets—a task particularly important for smaller providers, including practices in addition to larger datasets for organizations such as hospitals. Due to combining of logic-based and statistical methods, and the background knowledge, learning machines such as the AQ21 may be particularly suitable for this task.

In addition to the direct application in prediction of payments, some embodiments may have potential secondary implications. Rule-based models discovered by machine learning may be easy to understand by inexperienced people and represent patterns in incorrectly processed claims. Thus, by analyzing regularities, it may be possible to detect regularities in incorrectly processed claims on both provider and payer side. This may lead to improvement in claim processing and potentially to renegotiation or better specification of payor-provider contracts.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, a combination thereof, and/or the like, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

Some embodiments may employ processing hardware. Processing hardware may include one or more processors, computer equipment, embedded system, machines and/or the like. The processing hardware may be configured to execute instructions. The instructions may be stored on a machine-readable medium. According to some embodiments, the machine-readable medium (e.g. automated data medium) may be a medium configured to store data in a machine-readable format that may be accessed by an automated sensing device. Examples of machine-readable media include: magnetic disks, cards, tapes, and drums, punched cards and paper tapes, optical disks, barcodes, magnetic ink characters and/or the like.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) evaluating patient claim submissions. However, one skilled in the art will recognize that embodiments of the invention could be used to evaluate many different types of payment submissions such as invoicing for products and/or services or the like. For example, embodiments of the present invention may be used to determine whether loans will be approved, not approved, or provisionally approved. Additionally, such as system may be able to predict what interest rate may be charged for a particular applicant.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1) A non-transitory computer readable medium including a series of computer readable instructions configured to cause one or more processors to execute a method comprising:
a) generating a prediction employing a machine learning engine executing on the one or more processors, the prediction forecasting if first patient claim data when submitted to a payer will result in at least one of the following:
i) an approved submission;
ii) a denied submission; and
iii) an apparent payment variation; and
b) updating the machine learning engine using the prediction; and
wherein the machine learning engine is trained by:
i) generating labeled data by classifying at least one second patient claim data residing in a database of claim records and histories with at least one of the following:
(1) an anomaly detection label;
(2) a contract based label; and
(3) a combination of the above;
ii) employing the labeled data to train a claims classification model; and
iii) creating a predictive paid amount model employing at least one of the following:
(1) the labeled data;
(2) an amount paid on a claim; and
(3) a combination of the above.

2) The non-transitory computer readable medium according to claim 1, further including comparing the first patient claim data against the database of claim records and histories for completeness and consistency.

3) The non-transitory computer readable medium according to claim 1, further including employing the database of claim records and histories to resolve any of at least one missing value in the first patient billing data.

4) The non-transitory computer readable medium according to claim 3, wherein at least one of the at least one missing value includes a visit date.

5) The non-transitory computer readable medium according to claim 3, wherein at least one of the at least one missing value includes claim information.

6) The non-transitory computer readable medium according to claim 1, further including proving at least one of the following with a manual model:
a) the claims classification model;
b) the predictive paid amount model; or
c) a combination of the above.

7) The non-transitory computer readable medium according to claim 1, wherein the predictive paid amount model is created after filtering claims classified as at least one of the following:
a) the approved submission;
b) the denied submission; and
c) the apparent payment variation.

8) The non-transitory computer readable medium according to claim 1, wherein the predictive paid amount model is created while filtering claims classified as at least one of the following:
a) the approved submission;
b) the denied submission; and
c) the apparent payment variation.

9) The non-transitory computer readable medium according to claim 1, wherein the labeled data includes an expert specified label.

10) The non-transitory computer readable medium according to claim 1, further including predicting an amount for the apparent payment variation.

11) The non-transitory computer readable medium according to claim 1, further including the machine learning engine determining a pattern.

12) The non-transitory computer readable medium according to claim 1, wherein the first patient claims data is de-identified.

13) The non-transitory computer readable medium according to claim 1, further including formatting the first patient billing data into a machine learning data format.

14) The non-transitory computer readable medium according to claim 1, further including updating a contract using at least one of the following:
a) the claims classification model;
b) the predictive paid amount model;
c) at least one of the anomaly detection label; and
d) a combination of the above.

15) The non-transitory computer readable medium according to claim 1, further including updating a claim employing at least one of the following:
a) the claims classification model;
b) the predictive paid amount model;
c) at least one of the anomaly detection label; and
d) a combination of the above.

16) The non-transitory computer readable medium according to claim 1, further including not submitting a claim because of at least one of the following:
a) the claims classification model;
b) the predictive paid amount model;
c) at least one of the anomaly detection label; and
d) a combination of the above.

17) A method comprising:
a) generating a prediction employing a machine learning engine executing on one or more processors, the prediction forecasting if first patient claim data when submitted to a payer will result in at least one of the following:
i) an approved submission;
ii) a denied submission; and
iii) an apparent payment variation; and
b) updating the machine learning engine using the prediction; and
wherein the machine learning engine is trained by:
i) generating labeled data by classifying at least one second patient claim data residing in a database of claim records and histories with at least one of the following:
(1) an anomaly detection label;
(2) a contract based label; and
(3) a combination of the above;
ii) employing the labeled data to train a claims classification model; and
iii) creating a predictive paid amount model employing at least one of the following:
(1) the labeled data;
(2) an amount paid on a claim; and
(3) a combination of the above.

18) A non-transitory computer readable medium including a series of computer readable modules configured to cause one or more processors to execute a method, the modules comprising:
a) a payer-specific screening module configured to cause the one or more processors to generate a prediction employing a payer-specific machine learning engine and a payer-specific expert model, the prediction forecasting if first patient claim data when submitted to a payer will result in at least one of the following:
i) an approved submission;
ii) a denied submission; and
iii) an apparent payment variation; and
b) an update module configured to update the payer-specific machine learning engine using the prediction; and
wherein the payer-specific machine learning engine is trained by:
i) generating payer-specific labeled data by classifying at least one second patient claim data residing in a database of claim records and histories with at least one of the following:
(1) a payer-specific anomaly detection label;
(2) a payer-specific contract based label; and
(3) a combination of the above;
ii) employing the labeled data to train a claims classification model; and
iii) creating a payer-specific predictive paid amount model employing at least one of the following:
(1) the payer-specific labeled data;
(2) a payer-specific amount paid on a claim; and
(3) a combination of the above.

19) The non-transitory computer readable medium of claim 18, further including:
a) a service-specific screening module configured to cause the one or more processors to generate a service-specific prediction employing a service-specific machine learning engine and a service-specific expert model, the service-specific prediction forecasting if the first patient claim data when submitted to the payer will result in at least one of the following:
i) the approved submission;
ii) the denied submission; and
iii) the apparent payment variation; and
b) a service-specific update module configured to update the service-specific machine learning engine using the service-specific prediction; and
wherein the service-specific machine learning engine is trained by:
i) generating service-specific labeled data by classifying at least one second patient claim data residing in a database of claim records and histories with at least one of the following:
(1) a service-specific anomaly detection label;
(2) a service-specific contract based label; and
(3) a combination of the above;
ii) employing the service-specific labeled data to train a service-specific claims classification model; and
iii) creating a service-specific predictive paid amount model employing at least one of the following:
(1) the service-specific labeled data;
(2) a service-specific amount paid on a claim; and
(3) a combination of the above.

20) The non-transitory computer readable medium of claim 18, further including:
a) a general screening module configured to cause the one or more processors to generate a general prediction employing a general machine learning engine and a general expert model, the general prediction forecasting if first patient claim data when submitted to the payer will result in at least one of the following:
i) the approved submission;
ii) the denied submission; and
iii) the apparent payment variation; and
b) a general update module configured to update the general machine learning engine using the general prediction; and
wherein the payer-specific machine learning engine is trained by:
i) generating general labeled data by classifying at least one of the second patient claim data residing in the database of claim records and histories with at least one of the following:
(1) a general anomaly detection label;
(2) a general contract based label; and
(3) a combination of the above;
ii) employing the general labeled data to train a general claims classification model; and
iii) creating a general predictive paid amount model employing at least one of the following:
(1) the general labeled data;
(2) a general amount paid on a claim; and
(3) a combination of the above.
